(19) United States
(12) Patent Application Publication
(10) Pub. No.: US 2009/0054998 A1
(43) Pub. Date: Feb. 26, 2009

(54) SYSTEM AND PROCESS FOR OPTIMIZING PROCESS CONTROL

(75) Inventor: Al Beerbaum, Walnut Creek, CA (US)

Correspondence Address: CHEVRON CORPORATION, P.O. BOX 6006, SAN RAMON, CA, 94583-0806, US

(73) Assignee: Chevron U.S.A. Inc.

(21) Appl. No.: 11/843,772

(22) Filed: Aug. 23, 2007

(51) Int. Cl. G05B 13/04

(52) U.S. Cl. 700/29

(57) ABSTRACT

A system and process is provided for optimizing process control by linking planning linear programming and advanced process control optimization activities. The processing steps include feeding back constraint data to a planning LP, LP modeling a process, calculating optimum setpoints, and passing LP plan parameters to a plurality of APC controllers.

### FIELD OF THE INVENTION

The present invention relates to a system and process for optimizing process control. More particularly, the present invention relates to a system and process for optimizing process control by linking a dynamically adapted planning linear program and advanced process control optimization activities.

### BACKGROUND OF THE INVENTION

Refinery optimization activities are typically carried out in the three separate areas of refinery planning, process engineering (in support of operations) and process control engineering.

In planning, a linear programming (LP) model is typically used to compare and select from the range of options and economic trade-offs available to refiners. To keep models to a manageable size and solve-time, physical constraints (such as pump/compressor capacity, column hydraulics and heater/heat exchanger duty) are typically modeled only where relevant. Scheduling constraints such as inventory limitations, processing capacities, permit limits, planned outages and shipping are also modeled.

In process engineering, detailed non-linear models of individual refinery units are used to determine the trade-offs between throughput, energy and yield. These models are tuned to actual plant performance using test runs, and have good representation of equipment capacities, but poor or limited economic capability due to a focus narrowed to the particular process unit.

Advanced process control (APC) models also employ linear programming techniques. In these models, the relationships between manipulated variables (valve position) and process responses (changes in flow, temperature, pressure) are used together with feed and product prices to optimize operation locally at the process unit.

The transfer of information between the above three separate areas is carried out by human interaction. For example, people pass data via web documents and by telephone between the above separate areas.

No commercially proven technology exists that allows for the efficient use of all the above mentioned separate areas.

### SUMMARY OF THE INVENTION

The present invention achieves the advantage of a system and process for optimizing process control by linking a dynamically adapted planning linear program and advanced process control optimization activities.

In an aspect of the invention, a real time process control system includes: a planning linear programming component; and at least one advanced process control component, wherein optimization processing of the planning linear programming modeling component and the advanced process control component are linked together in a closed loop.

In another aspect of the invention, a real time process control method includes: feeding back predicted constraint data to a planning linear programming component; modeling a process; calculating an optimum series of setpoint adjustments; and passing the optimum series of setpoint adjustments to at least one advanced process controller component.

### DESCRIPTION OF THE DRAWINGS

FIG. 1 illustrates an embodiment of the invention, showing the system architecture and system process.

### DETAILED DESCRIPTION OF THE INVENTION

So that the above recited features and advantages of the present invention can be understood in detail, a more particular description of the invention, briefly summarized above, may be had by reference to the embodiments thereof that are illustrated in the appended drawings. It is to be noted, however, that the appended drawings illustrate only typical embodiments of this invention and are therefore not to be considered limiting of its scope, for the invention may admit to other equally effective embodiments.

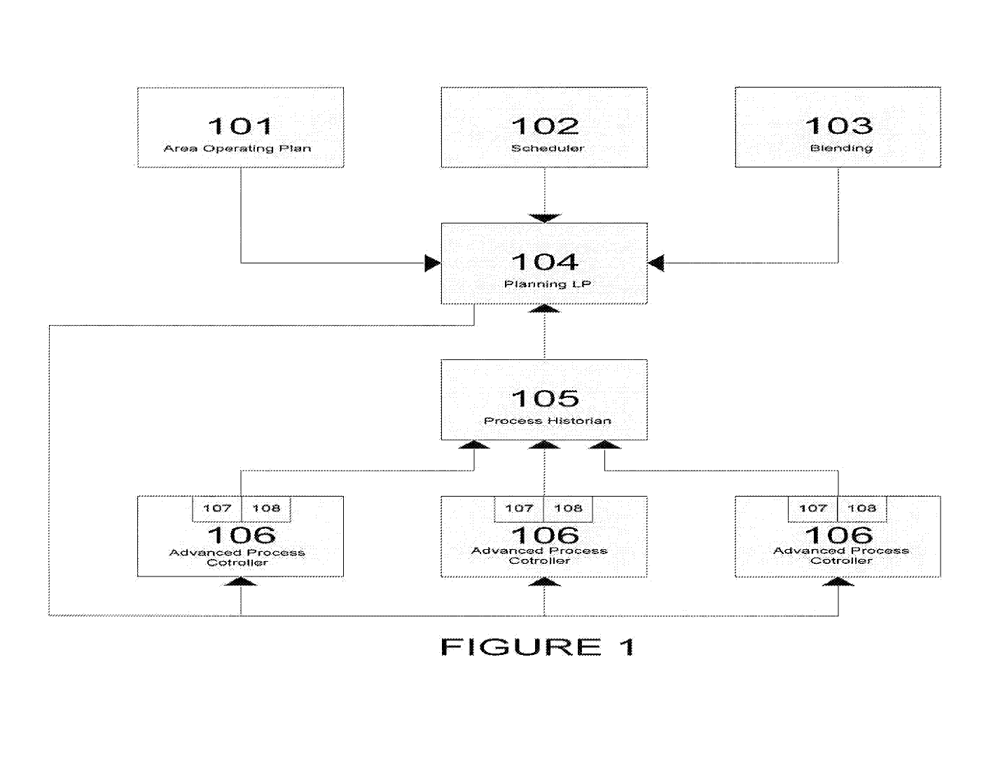

Embodiments describing the components and method of the present invention are referenced in FIG. 1. More specifically, the following embodiments describe the architecture and processes for implementing the present invention.

### System Architecture

As shown in FIG. 1, the system of the invention includes an Area Operating Plan (AOP) component 101, a scheduler component 102, a blends component 103, a planning linear programming (LP) component 104, a process historian (PH) component 105, advanced process controller (APC) components 106, forward looking APC components 107 and active constraints feedback components 108. The AOP component 101, the scheduler component 102 and the blends component 103 are in communication with and pass data to the planning LP component 104. The planning LP component 104 is in communication with and passes data to each of the APC components 106. Each of the APC components 106 passes data back to the programming LP component 104 via each of the forward looking APC components 107 and active constraints feedback components 108, and the PH component 105. As shown in FIG. 1 and described in the communication paths mentioned above, optimization processing of the planning linear programming component 104 and the advanced process control component 106 are linked together in a closed loop. Each component of the system is described below in more detail.

### Area Operating Plan

The AOP component 101 may be a software and/or hardware tool that analyzes product prices. Optimization is conducted according to highest profit margins for each product that may be produced at a manufacturing facility. The profit margin calculation is determined based on market prices versus manufacturing cost.

### Scheduler

The scheduler component 102 may be a software and/or hardware tool that supports a full range of scheduling activities such as optimizing blends, generating unit operations, arranging raw material receipts, handling feed stock run-out, updating baselines, managing unit yields, and schedule reporting.

The scheduler component 102 may dynamically interact with Gantt charts, managing activities like: receipt, shipment, unit operation, tank to tank transfer, pipeline transfer, blending, and facility status change. Gantt chart filtering allows schedulers to focus on vital activities.

Scheduling software and hardware functionality may also include: updating tank inventories, compositions, and qualities; updating linefill batch volumes, compositions, and qualities; and automatically reconciling activities and movements.

Schedulers have the challenge of developing the most profitable operating plan; meeting environmental and regulatory demands; and making decisions about capital expenditures for both compliance and profit improvements, while taking into account the following: alternative feedstocks and prices; alternative products and prices; product blending specifications; process plant configurations; capital improvements; purchases, sales, and trades; and inventories, imports, and exports.

### Blending

The blends component 103 may be a software and/or hardware tool that manages blend orders, as well as product and component data, and optimizes blend recipes to maximize production of on-spec product.

The functionality of the blends component 103 may include: assembling, reviewing and tracking the status of orders; validating scheduled blend order recipes based on current inventory data; tracking and validating blend header results and updating blend models used for blend batch optimization; receiving sample analysis data from a laboratory system to update tracked qualities or certify blends; and documenting final blend batch reports in order to meet production certification and reporting requirements.

The inputs to the blends component 103 may include: initial blend recipe and batch order targets; current data on component and product inventories and qualities and current blend ratio control status, lineup data and quality analyzers.

### Planning LP

The planning linear programming (LP) component 104 may be a software and/or hardware tool that models the operational reality of a production facility. Linear programming is an important field of optimization for several reasons. Many practical problems in operations can be expressed as linear programming problems. Certain special cases of linear programming, such as network flow problems and multicommodity flow problems are considered important enough to have generated much research on specialized algorithms for their solution. A number of algorithms for other types of optimization problems work by solving LP problems as sub-problems. Linear programming is heavily used in microeconomics and business management, either to maximize the income or minimize the costs of a production scheme. Some examples are gasoline blending, inventory management, portfolio and finance management, and resource allocation for human and machine resources.

An example of the planning LP component 104 includes a refinery LP model that contains end-to-end configuration of the refinery with a detailed representation of primary and secondary processing units, blending facilities, power and utilities. The model contains structural data, or fixed data, which represents the physical reality concerned, and variable data, which expresses the contingency of the particular problem. The addition of variable data like costs, prices, raw materials availabilities and products requests, process unit's capacities and product qualify specifications enables the model to set up a problem, from which infinite variant cases can be created and run to arrive at the optimal plan.

Mathematically, an LP model includes a matrix, or in other words, a set of data tables necessary and sufficient for automatic matrix generation. An exemplary refinery model may represent an LP matrix with 1,500 rows, 3,500 columns, 1,500 equations, 1,500 constraints and 5,000 variables. The planning LP component 104 may use different optimizers like MOPS (Freie Universitat Berlin, Berlin, Germany), XPRESS (Dash Optimization, Englewood Cliffs, N.J., USA), OSL (IBM, Armonk, N.Y., USA), etc. to solve the matrix.

Also, an exemplary refinery LP model may be configured with a single objective function of maximizing the profit as explained below: To maximize {S(Product value)−S(Raw Material cost)−S(Refinery Variable Costs), subject to the various constraints defined in the model including the inventory value and carrying cost parameters.

### Process Historian (PH) or Data Historian

The process historian (PH) component 105 may be a software and/or hardware tool that accommodates very large real-time and historical databases sized so that every recorded process point (called a “Tag”) is stored on-line near its original resolution for years. The PH component 105 enables users to easily access this high-resolution data to view a plant's current condition while providing a very clear and accurate picture of past operations. Data access to and from the PH component 105 is extremely fast. Users can retrieve the information they need within a few seconds regardless of the number of tags or the size of the archive.

PI provides data pipes from hundreds of different plant automation devices to bring all of the plant operating data into a common data format in a time series database. Real-time and historical data is available from this database to the entire plant.

More specifically, the PH component 105 is a real-time database optimized for storing and retrieving time series data. This is where the plant process information, i.e. pressures, flows, temperatures, setpoints, on/offs, etc. are stored. Examples of the major design features of PH Data Archive are listed below:

Captures all data related to operations or production. By capturing all process data in a single repository, the PH component 105 can create an accurate picture of current and past plant operations. All users can access the same information but with different views and perspectives. A process engineer can quickly analyze current process performance. A maintenance engineer can view historical data looking for degradation in equipment performance.

Stores data on-line long term. Several years worth of process data can be available within a few seconds of the request by the user or application. Users can pick up seasonal variations in the process, analyze equipment run times, and view cycles of production.

Stores data only once. Since the PH component 105 stores data in its fundamental form, the data can be used for different purposes without any data discrepancy. Users can query and view current, historical, or statistical data with client software. Users and applications can request the data to be calculated and delivered in many formats including summarized or “aggregate” data.

Stores data efficiently. The PH component 105 may use compression algorithms to store information for thousands of points to their original time resolution, without requiring vast amounts of disk storage.

Stores data to its original resolution. The PH component 105 is designed to store process and event information without loss of time resolution. Data is collected and stored as a function of its fundamental accuracy and time resolution. For example, if a process variable is capable of moving very quickly, data for that point is stored at a high time resolution. The compression algorithm ensures that data retrieved is always represented within the accuracy specified for each point.

### Advanced Process Controllers

The advanced process controller (APC) components 106 may be software and/or hardware tools that include three major components: a computer-simulation model that integrates process knowledge and historical data; control and optimization algorithms; and current, real-time process information.

The APC components 106 may include different kinds of process controls tools, for example, model predictive control (MPC), dynamic matrix control (DMC), statistical process control (SPC), Run2Run (R2R), fault detection and classification, sensor control and feedback systems. The APC controller components 106 solve multivariable control problems or discrete control problems. Although not shown in the figures, the APC controller components 106 are also in communication with a distributed control system (DCS). The APC components 106 calculate setpoints that are sent to regulatory controllers. Since the APC 106 include the dynamic relationship between variables, it can predict in the future how variables will behave. Based on these predictions, actions can be taken how to maintain variables within their limits.

### Forward Looking APC

The forward looking APC components 107 may be software and/or hardware tools included in the APC component 106. The forward looking APC components 107 include a control engine that uses the process model selected by the modeling engines' control algorithm to predict the future direction of the process and generate a series of control outputs, based on the history of all the variables and predictions.

### Active Constraints Feedback

The active constraints feedback components 108 may be software and/or hardware tools included in the APC component 106. The active constraints feedback components 108 analyze where and what the operational limitations are.

### System Process

The system processing of the invention is described as follows:

First, predicted constraint data from the active constraints feedback components 108 is fed back to the planning linear programming (LP) component 104 via the forward looking APC components 107 and the process historian (PH) component 105. The constraint data describes where and what the operational limitations are. As described above, the process historian (PH) component 105 functions as a repository or storage for the constraint data before being fed back to the planning LP component 104.

Next, the planning linear programming (LP) component 104 models a plant process based on predicted constraint data and input data from the area operating plan (AOP) component 101, the scheduler component 102 and the blends component 103. The planning LP component 104 then calculates an optimum series of setpoint adjustments and arrives at an optimal plan as described above.

The optimum setpoints and LP plan parameters calculated by the planning LP component 104 are then passed to the advanced process controller (APC) components 106 to complete the closed control loop. The advanced process controller (APC) components 106 determine where the process is limited and in turn feeds back this information to the planning LP component 104. Due to this closed loop configuration, the planning LP component 104 of this invention is a dynamic component.

The advanced process controller (APC) components 106 can look back in time by, for example, several hours, and evaluate what the situation will be in the future by several hours if no future setpoint adjustments are made. If the evaluated future situation is not optimum, the APC calculates a series of future setpoint adjustments to bring the situation to optimum.

Three mechanisms address optimization opportunities at three levels of control hierarchy. Opportunities at the process unit level are captured by APC using a view of the past and the future in the range of about one to two hours. Coordination opportunities at the refinery level are captured by a large but less detailed APC in the range of about four to eight hours. Refinery opportunities involving scheduling, inventory and outages are captured by a multi-time period planning linear program in the range of about seven to fourteen days.

Process unit APC concerns itself with producing on-test unit products and intermediate streams, with energy efficiency and with regulating or maximizing unit throughput. Occasionally a unit APC may measured potential disturbance or constraint outside the unit itself, but generally the focus is within the unit. Two hours is generally sufficient to capture effects of adjustments within the unit thus allowing for a two-hour time horizon describes nearly all refinery unite.

The ‘whole refinery’ APC addresses unit to unit opportunities and limitations. For example, feeding a high sulfur crude in the front of the refinery affects H₂S production at the back end of the refinery. To control H₂S production to a limit requires timing and rate information that spans the refinery. This APC coordinates all movement that involves distributing adjustment among multiple unit APCs. The timing scope for this coordination is chosen to include direct movement from unit to unit without intermediate tankage.

Whole refinery opportunities that include tankage are captured by the multi-time period linear program (LP). This LP tracks tank composition as well as volume, and keeps detailed crude assay records. It also captures the gasoline batch blending schedule for up to 14 days in the future to constrain optimization opportunities. The refinery LP addresses timing differently than APC in that it models the future in seven or more whole day time periods, and puts out optimization direction to APC in view of all applicable scheduling constraints.

What is claimed is:

1. A real time process control system comprising:
a planning linear programming component; and
at least one advanced process control component,
wherein optimization processing of the planning linear programming modeling component and the advanced process control component are linked together in a closed loop.

2. The real time process control system according to claim 1, further comprising:
an area operating plan component,
wherein the area operating plan component is in communication with the planning linear programming component.

3. The real time process control system according to claim 1, further comprising:
a scheduler component,
wherein the scheduler component is in communication with the planning linear programming component.

4. The real time process control system according to claim 1, further comprising:
a blends component,
wherein the blends component is in communication with the planning linear programming component.

5. The real time process control system according to claim 1, further comprising:
a process historian component,
wherein the process historian component is in communication with the planning linear programming component and the at least one advanced process control component.

6. The real time process control system according to claim 1, wherein the at least one advanced process control component comprises:
a forward looking advanced process control component,
wherein predictive data is fed back to the planning linear programming component via the forward looking advanced process control component.

7. The real time process control system according to claim 1, wherein the advanced process control component comprises:
an active constraints feedback component,
wherein active constraints are fed back to the planning linear programming component via the active constraints feedback component.

8. A real time process control method comprising:
feeding back predicted constraint data to a planning linear programming component;
modeling a process;
calculating an optimum series of setpoint adjustments; and
passing the optimum series of setpoint adjustments to at least one advanced process controller component.

9. The real time process control method according to claim 8, further comprising the step of:
storing the predicted constraint/data before feeding back to the linear programming component.

10. The real time process control method according to claim 8, further comprising the step of:
inputting area operating plan data into the planning linear programming component.

11. The real time process control method according to claim 8, further comprising the step of:
inputting scheduler data into the planning linear programming component.

12. The real time process control method according to claim 8, further comprising the step of:
inputting blends data into the planning linear programming component.

13. The real time process control method according to claim 8, further comprising the step of:
determining and feeding back process limitations to the planning linear programming component.
